(19) United States
(12) Patent Application Publication
(10) Pub. No.: US 2026/0364868 A1
(43) Pub. Date: Nov. 19, 2026

(54) MULTILAYER FILM, METHOD FOR MAKING THE SAME AND DECORATIVE ARTICLE

(71) Applicant: Taghleef Industries S.L., Alcalá La Real, Jaén (ES)

(72) Inventors: Manuel LOPEZ QUESADA, Alcalá La Real, Jaén (ES); Cristina LOPEZ JAEN, Alcalá La Real, Jaén (ES)

(21) Appl. No.: 19/132,884

(22) PCT Filed: Nov. 28, 2023
(86) PCT No.: PCT/EP2023/083275

§ 371 Date: May 27, 2025

(30) Foreign Application Priority Data
Nov. 29, 2022 (IT) 102022000024585

(51) Int. Cl. B29C 48/21; B29C 48/00; B29C 48/22; B29K 23/00; B29K 105/00

(52) U.S. Cl. CPC B29C 48/21; B29C 48/002; B29C 48/22; B29K 2023/06; B29K 2023/08; B29K 2023/12; B29K 2023/14; B29K 2105/0044; B29K 2995/002; B29K 2995/0024; B29K 2995/0025; B29K 2995/0026; B29K 2995/0053; B29K 2995/0072

(57) ABSTRACT

A multilayer film to be applied on flooring articles or furniture articles is described. The multilayer film includes a base layer including an oriented film and a wear layer associated with a face of the base layer and includes a transparent film.

### FIELD OF THE INVENTION

The present invention concerns a multilayer film based on polyolefin material. More particularly, the present invention concerns a multilayer film based on polyolefin material for flooring applications, especially laminate flooring applications, or furniture applications.

### BACKGROUND OF THE INVENTION

In the market for laminate flooring applications, a pressed wood substrate such as Medium Density Fibreboard (MDF) or High Density Fibreboard (HDF) has long been used, to which a printed paper sheet with wood patterns is glued, and on which an ultraviolet curing varnish is applied, to provide resistance to wear.

A problem of this type of conventional product is that it has no resistance to humidity, and cannot be used in floor applications for kitchens or bathrooms, where water is present in a huge proportion.

The known laminate floors introduced in the market have a base layer with a printed face and a wearing layer applied on a surface of the base layer. The printed face aims at making the laminate floor look like wood, for example. Both layers are made of PVC-type plastic materials. The advantage of this type of product compared to wood is its resistance to humidity.

A drawback of the known laminate floors is that some of the plasticizers used in its manufacture are considered harmful for humans. Another drawback, regarding an aesthetic aspect, is that the known laminate flooring reproduces the wood appearance but do not reproduce the irregular surface of natural wood and provide a completely flat and smooth surface, which does not allow to have the feeling of touching wood.

Solutions have been proposed to solve this latter problem.

For Example, EP-A-3865300 describes a transparent film for protecting a picture layer on one side of a substrate, which includes a surface protective layer and a transparent resin layer. The film has a pattern of protrusions and depressions on a surface of the protective layer side.

EP-A-3957477 discloses a transparent film to be laminated on a surface including a picture layer, the transparent film having a pattern of protrusions and depressions on a side opposite to the side to be laminated. The film is laminated by thermal lamination using an embossing roll to laminate and to produce embossing on the hot roll contact side. This is a typical PVC process for lamination and embossing.

EP-B-2130991 is similar to the previous prior art document and describes a laminate film wherein a printed paper is thermolaminated with a thermoplastic film which is embossed at the same time.

EP-A-3950326 Discloses a multilayer transparent wear film comprising two materials that have different melting temperatures and including a flame retardant.

JP-A-2001159228 discloses a multilayer film having a transparent thermoplastic resin layer containing an absorber of ultraviolet radiations and coated with a protective layer, an opaque thermoplastic resin layer and a foamed resin layer. This documents also discloses a method to produce the film, wherein the transparent thermoplastic resin layer is coated with the protective material and is successively embossed.

These known films still have drawbacks, in particular that of providing an embossed layer that is embossed on both sides, which entails the use of high quantities of adhesive to reach a correct adhesion on the other layers of the film.

It is therefore necessary to devise a laminate floor which can overcome at least one of the drawbacks of the known art.

To do so, it is necessary to solve the technical problem of providing a laminate floor with high resistance to wear, water resistant, which is not harmful for human health and which requires lower quantities of adhesive to achieve a correct adhesion of the embossed layer.

In particular, a scope of the present invention is that of making a multilayer film for flooring applications having an embossed layer which requires lower quantities of adhesive, when compared to the films of the state of the art.

Another scope of the present invention is that of making a multilayer film, to be applied on floor materials, with high resistance to wear and humidity and which is free of PVC.

Another scope of the present invention is that of making a multilayer film which can provide an increased wood-like appearance and an increase wood-like touch feeling.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants of the main inventive idea.

In accordance with the aforesaid objectives and in order to solve the aforesaid technical problem in a novel and original manner, obtaining also relevant advantages with respect to the state of the art, a method according to the invention for making a multilayer film to be applied on a flooring article or a furniture article, provides a step of laminating a base layer, comprising an oriented opaque polyolefin film, with a wear layer containing a transparent polyolefin film and an embossed layer and which comprises a first face situated towards the outside that has an embossing. Doing so, the wear layer comprises a first face that is embossed, i.e. which has a plurality of projections and depressions randomly distributed on the first face.

The wear layer has therefore only one face that is embossed, the second face thereof being smooth, i.e. not being embossed. In particular, the second face of the wear layer has an average roughness below 20 μm, preferably below 15 μm, more preferably below 10 μm or even lower. The roughness is measured by a roughness tester, in particular a contact roughness tester.

According to embodiments, the method also provides a step of coating the embossed face of the wear layer with a protective material, in particular a protective lacquer. It descends that the step of coating is executed after the embossing of the embossed layer. Providing the coating step after the embossing step allows to keep the coating layer undamaged, so that its resistance lasts longer with respect to the films of the prior art.

According to embodiments, the method provides a step of embossing the embossed layer prior to the step of laminating the base layer and the wear layer.

In accordance with embodiments, prior to the above lamination step, the method provides a step of extruding and orienting a transparent polyolefin film followed by a successive step of extrusion coating of a melted second layer of transparent polyolefin polymer.

The method advantageously provides, before or during the extrusion coating step, the step of embossing the second layer of transparent polyolefin polymer, which becomes the embossed layer. Preferably the embossing is carried out by cooling the second layer on top of an embossed chill roll, to generate a wear layer with an embossed surface. Doing so, the wear layer has a second face, opposed to the embossed first face, that is smooth, i.e. that is not embossed. Such a smooth second face is easier to be adhered to the base layer, and requires lower quantities of adhesive. The second layer of transparent polyolefin polymer becomes the embossed layer of the multilayer film.

In accordance with embodiments, between the extrusion step of the transparent polyolefin film and the coextrusion step of the transparent polyolefin film with the embossed layer is provided an orientation step of the transparent polyolefin film. The orientation step preferably comprises a bi-axial orientation of the transparent polyolefin film.

In particular, the base layer is opaque, in the sense that it is not transparent, i.e. it is pigmented or printed, in particular printed on a face.

In accordance with embodiments, the base layer and the wear layer are laminated with an adhesive layer.

Preferably, the adhesive is an acrylic, solvent base PU or solvent less PU adhesive, more preferably a PU solvent-less based adhesive.

In accordance with embodiments, the adhesive has a weight, or grammage, that is less than 20 g/m², preferably less than 10 g/m², more preferably less than 5 g/m².

It is therefore advantageous to provide that the faces of the base layer are smooth, so that they can be glued, or more generally applied, on another surface. It is also advantageous that the second face of the wear layer, opposed to the first face, is smooth as well so that it can be applied, or glued, to a face of the base layer.

In accordance with embodiments, the base layer is a bi-axially oriented polyolefin film, for example chosen between polypropylene (PP), polyethylene (PE) or copolymers thereof. The base layer is preferably a bi-axially oriented polypropylene (BOPP) film. Such a base layer can be printed using techniques like standard flexo, off-set, rotogravure or digital printing.

According to embodiments, the transparent polyolefin film is a bi-axially oriented transparent polyolefin film, for example chosen between polypropylene homopolymer, polypropylene copolymer or polyethylene.

In accordance with embodiments, the embossed layer is a polyolefin film, for example made of polypropylene, polypropylene copolymer, polyethylene or polyethylene copolymer. The embossed layer is not oriented.

In accordance with embodiments, the wear layer and/or the base layer comprises a UV-protecting agent. Preferably, the UV-protecting agent is a UV-stabilizer. More preferably, the UV-protecting agent is a Hindered-Amine Light Stabilizer (HALS). The UV-protecting agent is advantageously embedded in the composition of the layer.

In accordance with embodiments, the wear layer also comprises a curable lacquer, i.e. a lacquer that can undergo a curing to improve wear resistance of the layer. The lacquer can be an acrylic lacquer, or a polyurethane (PU) lacquer or mixture of both. Preferably the lacquer is cured by means of UV or EB radiation. The lacquer can also be matted, by means of a suitable treatment, in particular with an excimer UV lamp. Some particles can be added to improve wear resistance like Quartz, Topaz or Corundum.

In accordance with the aforesaid objectives and in order to solve the aforesaid technical problem in a novel and original manner, obtaining also relevant advantages with respect to the state of the art, a multilayer film according to the present invention, to be applied on flooring articles or furniture articles, comprises a base layer comprising an oriented opaque polyolefin film and a wear layer associated with a face of the base layer and comprising a transparent polyolefin film and an embossed layer. Advantageously the wear layer has only one embossed face. Preferably, the base layer consists in the oriented opaque polyolefin film, and/or the wear layer consists in the transparent polyolefin film and the embossed layer. More preferably, the transparent polyolefin film is an oriented transparent polyolefin film. The polyolefin film and the embossed layer are reciprocally adhered. Positively, the multilayer film is obtainable by the method above.

Advantageously, the embossed layer is provided as a coating on the transparent polyolefin layer. In particular it is applied on the transparent polyolefin film by means of extrusion coating. The embossed layer has an embossed face and, advantageously, a smooth face opposed to the embossed face. In particular, it is to be understood that the face opposed to the embossed face is not embossed. Preferably, the face opposed to the embossed face an average roughness below 20 μm, preferably below 15 μm, more preferably below 10 μm or even lower. The measure has been made by means of a roughness tester, in particular a contact roughness tester.

The wear layer has a first face which is embossed, i.e. which has a plurality of projections and depressions randomly distributed on the first face. The first face of the wear layer, corresponding to the embossed face of the embossed layer, is advantageously located toward the outside of the film, i.e. it is the external face of the multilayer film. Such first face of the wear layer is not the face that is directly associated with the base layer. As will be explained more in detail in the following description, the embossed face of the wear layer is obtained by adding, on the transparent polyolefin film, a melted polyolefin layer by extrusion coating, so that the melted layer is applied directly thereon, without the use of adhesives. This extruded melted layer is cooled on top of an embossed chill roll, which generates the embossed surface during the cooling of the polyolefin extruded layer.

The wear layer has also a second face, opposite the first face, which is smooth. Such second face, which corresponds to a face of the transparent polyolefin film, is provided for being adhered to the base layer.

The embossed face therefore allows to provide the external surface of the multilayer film with a peculiar aspect and a peculiar texture which can remind that of a natural material, such as wood for example. Such embossed surface is suitable to be oriented towards the exterior when the multilayer film is applied on an article, in particular a flooring article. The smooth second face of the wear layer allows it to be correctly adhered to the base layer by using lower quantities of adhesive when compared to the films of the state of the art.

In particular, the base layer is opaque in the sense that it is not transparent, i.e. it is pigmented or has a printing on a face. In accordance with embodiments, the wear layer is fixed directly on a face of the base layer, preferably by gluing. So, in a preferred embodiment, the multilayer film also comprises an adhesive layer between the base layer and the wear layer. Preferably, the adhesive is acrylic, solvent base PU or solvent less PU adhesive, more preferably a PU solvent-less based adhesive.

In accordance with embodiments, the adhesive has a weight, or grammage, that is less than 20 g/m², preferably less than 10 g/m², more preferably less than 5 g/m².

It is therefore advantageous to provide that the first face of the base layer is smooth, so that the second face of the wear layer, which is smooth as well, can be applied, or glued, easily and efficiently to the base layer, using a minor quantity of adhesive with respect to the prior art.

In accordance with embodiments, the base layer is a bi-axially oriented opaque polyolefin film, for example chosen between polypropylene (PP), polyethylene (PE) or copolymers thereof. The base layer is preferably a bi-axially oriented polypropylene (BOPP) film. Such a base layer can be printed using techniques like standard flexo, off-set, rotogravure or digital printing.

In accordance with embodiments, at least one of the faces of the base layer is treated to increase the surface tension, in particular by means of a corona, flame or plasma treatment. Preferably, both faces of the base layer are treated by means of a corona, flame or plasma treatment. More preferably, the surface tension of one or both faces of the base layer is of at least 38 dyne/cm.

According to embodiments, the transparent polyolefin film is a bi-axially oriented transparent polyolefin film, for example chosen between polypropylene homopolymer, polypropylene copolymer, polyethylene or polyethylene copolymer.

In accordance with embodiments, the embossed layer is a polyolefin film, for example made of polypropylene, polypropylene copolymer, polyethylene or polyethylene copolymer.

In accordance with embodiments, the wear layer comprises a UV-protecting agent. Preferably, the UV-protecting agent is a UV-stabilizer. More preferably, the UV-protecting agent is a Hindered-Amine Light Stabilizer (HALS). The UV-protecting agent is advantageously embedded in the composition of the layer.

In accordance with embodiments, the base layer comprises a UV-protecting agent. Preferably, the UV-protecting agent is a UV-stabilizer. More preferably, the UV-protecting agent is a Hindered-Amine Light Stabilizer (HALS). The UV-protecting agent is advantageously embedded in the composition of the layer.

It is possible to provide that only one of the wear layer or the base layer are UV-stabilized, or also that both the wear layer and the base layer are UV-stabilized.

In accordance with embodiments, the wear layer also comprises a curable lacquer, i.e. a lacquer that can undergo a curing to improve wear resistance of the layer. In particular, the first face of the wear layer has a coating made of the curable lacquer. The lacquer is an ultraviolet (UV) curing lacquer or an electron beam (EB) curing lacquer. The lacquer can be an acrylic lacquer, polyurethane (PU) lacquer or mixture of both. The lacquer can also be matted, by means of a suitable treatment, in particular by exposure to an excimer UV lamp.

According to embodiments, the lacquer contains mineral particles to improve wear resistance of the wear layer. The mineral particles can be Quartz, Topaz or Corundum particles, or mixtures thereof.

According to embodiments, the base layer has a thickness comprised between 25 μm and 100 μm, preferably between 30 μm and 70 μm.

According to embodiments, the wear layer has a thickness comprised between 75 μm and 400 μm, preferably between 85 μm and 300 μm, more preferably between 100 μm and 200 μm.

In accordance with embodiments, the multilayer film has a total thickness comprised between 100 μm and 425 μm, preferably between 115 μm and 350 μm, more preferably between 125 μm and 225 μm.

The multilayer film of the present invention is suitable to be applied on flooring articles for any kind of use, also in kitchens and bathrooms, where water is present.

The multilayer film of the invention can be applied on wood panels, for example MDF or HDF wood panels, resulting in a flooring laminate having high humidity and water resistance and an excellent wear resistance.

The multilayer film of the invention can also be applied on plastic panels, such as polyolefins loaded with fillers, resulting in a flooring laminate having a water resistance that is improved with respect to the flooring laminate with a wood panel and the multilayer film of the invention.

According to one aspect of the present invention, a decorative article is provided which comprises a flooring article or a furniture article on a surface of which is applied a multilayer film composed of a base layer comprising an oriented opaque polyolefin film and a wear layer associated with a face of the base layer and comprising a transparent polyolefin film and an embossed layer, wherein the wear layer has a first face that is embossed and a second face, opposed to the first face, which is smooth. The polyolefin film and the embossed layer are reciprocally adhered, in particular without adhesives.

Advantageously, the multilayer film is as defined above.

According to embodiments, the decorative article comprises a wood panel as a flooring article, for example a MDF or HDF wood panel. Alternatively, the decorative article may comprise a plastic panel, for example made of a polyolefin SPC (Stone Polymer Composite).

According to one aspect of the present invention, a method for making a decorating article provides to laminate, on a flooring article or a furniture article, a multilayer film composed of a base layer comprising an oriented opaque polyolefin film and a wear layer associated with a face of the base layer and comprising a transparent polyolefin film and an embossed layer, wherein the wear layer has a first face that is embossed and a second face, opposed to the first face, which is smooth.

Advantageously, the multilayer film is as defined above.

According to embodiments, the multilayer film is laminated on the flooring article or the furniture article using an adhesive like, PVAC, Acrylic or polyurethane types. Polyurethane is preferred.

According to embodiments, the multilayer film is laminated on a flooring article, preferably a wood panel, such as an MDF or HDF wood panel, or a plastic panel, such as a polyolefin-based panel.

### ILLUSTRATION OF DESIGNS

These and other aspects, features and advantages of the present invention will become apparent from the following description of some embodiments provided by way of non-restrictive example, with reference to the accompanying drawings wherein:

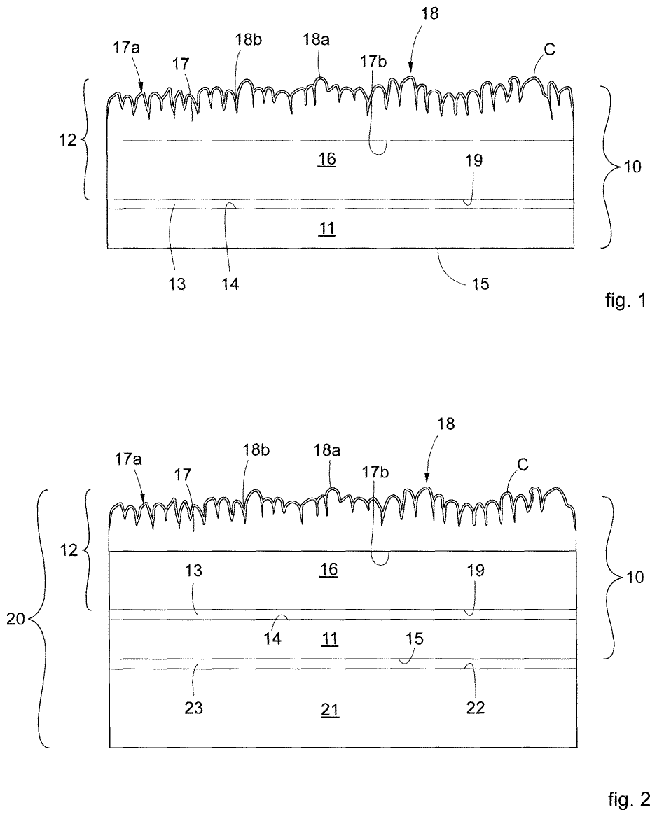

FIG. 1 is a schematic section view of a multilayer film in accordance with the present invention; and

FIG. 2 is a schematic section view of a decorative article comprising a flooring article laminated with a multilayer film in accordance with the present invention.

It is to be highlighted that in the present description, phraseology and terminology used here, such as for example wording horizontal, vertical, forward, back, high, low, inside and outside, with their variations, have the only purpose of better illustrating the present invention with reference to the figures of the attached drawings and shall not be in any way used for limiting the scope of the invention itself, or the scope of protection defined in the attached claims.

Furthermore, the persons skilled in the art, will acknowledge that some dimensions, or features, in the figures can be increased, deformed, or shown in a non-conventional way, or not proportionally to provide a more easily understandable version of the present invention. When in the following description, dimensions and/or values are specified, such dimensions and/or values are provided for illustrative purpose only and shall not be construed as limiting the scope of protection of the present invention, unless such dimensions and/or values are present in the attached claims.

To facilitate understanding, the same reference numbers have been used, where possible, to identify identical common elements in the figures. It is understood that elements and characteristics of one embodiment can conveniently be incorporated into other embodiments without further clarifications.

### DETAILED DESCRIPTION OF SOME EMBODIMENTS

With reference to FIG. 1, a multilayer film 10 according to the present invention, to be applied on flooring articles or furniture articles, comprises a base layer 11 on which a wear layer 12 is laminated, by means of an adhesive layer 13 interposed between the base layer 11 and the wear layer 12.

The base layer 11 is a BOPP film that is printed, and has a first face 14, on which the adhesive layer 13 is directly applied, and a second face 15 suitable to be applied on a flooring article 21 or a furniture article. Both the first face 14 and the second face 15 of the base layer are smooth, in order to improve the adhesion to the wear layer 12 and to the flooring or furniture article. The smooth faces allow to reduce the quantity of adhesive material necessary to obtain a good adhesion of the layers.

The base layer 11 is printed in correspondence with the first surface 14 by flexo, offset or rotogravure. In order to be able to see the printing, the adhesive layer 13 and the wear layer 12 are both transparent. The base layer 11 has also undergone a corona treatment on both sides, to improve their bonding to inks and adhesives. It is possible to provide that the base layer undergoes a flame or plasma treatment.

The wear layer 12 is made of a transparent oriented polyolefin film 16, in particular a bi-axially oriented polypropylene BOPP film 16, and an embossed layer 17 made of polypropylene (FIG. 1) and having only one embossed face 17a. The embossed layer 17 has a second face 17b, opposed to the embossed face 17a, which is smooth, in the sense that it is not embossed. Examples of commercially polymer materials for the production of wear layer 12 are PP 044 W3F, PP 064 M1F or PR 255 W1F from Repsol.

The wear layer 12 has a first face 18 that is situated externally with respect to the multilayer film 10, and thereby constitutes the external surface of the multilayer film 10, and a second face 19 on which is directly applied the adhesive layer 13. The second face 19 of the wear layer 12 is also smooth, like the faces 14, 15 of the base layer 11, in order to improve adhesion of the adhesive layer 13. By a smooth surface it is intended, in the present specification, a surface having an average roughness below 20 μm, in particular in the order of 10-15 μm or even lower. These values are to be obtained using a roughness tester. The average roughness Ra is measured with a surface tester such as TR 200 Roughness Tester from company TIME High Tech.

The use of a BOPP transparent film 16 in the wear layer 12 is particularly useful as it provides the multilayer film with better mechanical properties, especially as regards rigidity of the multilayer film, thereby allowing to make thinner layers for an equal rigidity.

The first face 18 of the wear layer 12 is the embossed face of the embossed layer 17. It provides both an aspect and a texture that look like those of a natural material, for example natural wood. In this case, the printing made on the base layer advantageously reproduces the color and the pattern of a wood.

The embossment of the first face 18 contains a plurality of projections 18a and depressions 18b that are alternated and distributed in a predetermined manner, so as to reproduce the pattern of wood. The projections and depressions are shaped as lines, and can be circular or curved or straight, in order to reproduce the grain of the wood. The embossing has an average thickness in a range from 50 to 200 μm.

Roughness of the embossing has been calculated measuring the total thickness of the multilayer film 10 on the highest areas. Average thickness of the multilayer film 10 is then calculated based on a sample of 100 mm×100 mm, the weight of which is measured. Knowing the density of the polymers used to make the multilayer film 10, average thickness thereof is calculated, thus allowing to calculate the average roughness by difference with total thickness measured on the highest areas.

In order to improve resistance of the film 10 with respect to the light irradiation, in particular sunlight irradiation, the base layer 11 and the wear layer 12 both comprise HALS as a UV-stabilizer. This makes the film 10 particularly resistant to the effect of the UV, i.e. for example depolymerization over time. In the wear layer 12, the HALS is present in both the transparent BOPP film 16 and in the embossed layer 17.

To improve the wear resistance of the film 10, the first face 18 of the wear layer 12 has a coating layer C made of a curable lacquer, such as an acrylic, polyurethane or mixture of both lacquers, which can be cured through UV radiation or Electron beam. The coating layer C covers the whole surface of the first face 18 of the wear layer 12. The first face 18 of the wear layer 12 has also a matted aspect, due to a treatment of the lacquer by means of an UV excimer lamp, to obtain a gloss lower than 10%. The gloss has been measured using ASTM D 2457 at 45°C. The excimer UV lamps have a special wavelength at 172 nanometer that create a shrinking of the surface of the UV or EB coating, and as a result, the surface becomes matted. Additionally, a pre-geling UV lamp can be used to reduce more the gloss level. This lamps are installed before the total curing of the lacquer with UV or EB (Electron Beam) technologies. The matted face gives the film 10 the aspect of a wood that has not been sanded.

Some mineral particles can be added to the lacquer, i.e. integrated into the coating layer C, to improve wear resistance thereof. Examples of such mineral particles encompass Quartz, Topaz or Corundum.

The adhesive layer 13 is a PU solvent-less adhesive layer and is applied with a grammage comprised between 1 g/m² and 5 g/m². Thanks to the smooth faces 14, 15 of the base layer 11 and the smooth second face 17 of the wear layer 12, the base layer 11 and the wear layer 12 are perfectly adhered, even with this amount of adhesive. It has been verified that the bonding adhesion is greater than 275 N/m (7 N/inch). The delamination force has been measured using ASTM D882, using samples of one inch width, and measuring the adhesion strength with an angle of 180°.

The film 10 has been obtained by laminating together the base layer 11, the adhesive layer 13 and the wear layer 12. The base layer 11 and the wear layer 12 were previously produced separately.

The base layer 11 has been obtained through flat die casting of a polypropylene film, which contains HALS and titanium dioxide as additives. The polypropylene film has then been stretched in both the machine direction and transverse direction. The obtained BOPP has then been treated to increase surface tension, through corona treatment on both faces and printed, in a separate step, on one face by means of flexo, off-set, rotogravure or digital printing.

The wear layer 12 has been obtained by extruding a transparent polypropylene film and by orienting the same bi-axially. The obtained BOPP film has been then coextruded with a transparent polypropylene melted layer to generate the embossed face. During the coextrusion, a chill roll is used that has an embossing surface put in contact with the face of the polypropylene melted layer while it is still melted. This contact with the embossing surface makes the embossing only on the exposed face of the polypropylene film. The back surface of the polypropylene melted layer is not impacted by the embossing, so that its adhesion to the BOPP film is optimized. The polyolefin used already contained HALS as a UV-stabilizer. The embossed surface is corona treated and then coated with the curable lacquer and treated with an UV excimer lamp to obtain the mat effect. This process can be done in one step if the machine is designed to do so, or the lacquer coating can be made in a separate step.

The film 10 so-obtained has an improved resistance to humidity when compared to the known films to be applied on flooring articles or furniture articles, which makes it a product with high added value, as it can guarantee high resistance to humidity and high wear resistance.

With reference to FIG. 2, a decorative article 20 comprises a flooring article 21 on a face 22 of which is laminated the film 10 as in FIG. 1. The flooring article is a compacted wood panel, but it is possible to provide that the flooring article is also a plastic panel of the SPC (Stone Polymer Composite) type, such as a panel made of polyolefin loaded with natural fillers. The film 10 can be applied on such kind of panels.

The film 10 is adhered to the surface 22 of the wood panel 21 by an adhesive layer 23, in particular of the PVAC, acrylic or polyurethane type. Polyurethane is the most recommended.

Thanks to the film 10, the decorative article 20 has a high humidity and water resistance as well as an excellent wear resistance. The decorative article 20 can be used in places where there is a lot of water, such as kitchens or bathrooms.

It is clear that modifications and/or additions of parts or phases may be made to the multilayer film 10, the method for making it and the decorative article 20 as described heretofore, without departing from the field and scope of the present invention as defined in the claims.

It is also clear that, even though the present invention is described with reference to specific examples, an expert of the field can realize other equivalent forms of multilayer film 10, method for making it and decorative article 20 having the features expressed in the claims and so being all included in the scope of protection defined thereby.

In the following claims, the references in brackets have the only scope of facilitating reading and shall not be considered as limitative factors as far as the scope of protection intended in the specific claims is concerned.

1. A method for making a multilayer film to be applied on flooring articles or furniture articles, the method comprising:
laminating a base layer comprising an oriented opaque polyolefin film that is pigmented or printed, and a wear layer comprising a transparent polyolefin film and an embossed layer, wherein the embossed layer comprises a first face oriented outward that has an embossing; and
coating the embossing with a protective material.

2. The method of claim 1, wherein the wear layer has only one face that is embossed.

3. The method of claim 1, further comprising embossing the embossed layer prior to laminating the base layer and the wear layer.

4. The method of claim 1, prior to laminating the base layer and the wear layer:
extruding and orienting the transparent polyolefin film; and
extrusion coating the transparent polyolefin film with a melted second layer of transparent polyolefin polymer to form the wear layer,
wherein the wear layer has a second face, opposed to the first face, that is smooth.

5. The method of claim 4, further comprising embossing the second layer of transparent polyolefin polymer to form the embossed layer while the second layer is melted on the transparent polyolefin film.

6. The method of claim 5, wherein embossing the second layer of transparent polyolefin polymer comprises cooling the second layer on top of an embossed chill roll.

7. The method of claim 1, wherein the base layer and the wear layer are laminated with an adhesive therebetween.

8. A multilayer film to be applied on flooring articles or furniture articles, the multilayer film comprising:
a base layer comprising an oriented opaque polyolefin film and a wear layer over a face of the base layer,
wherein the base layer is pigmented or printed, and
wherein the wear layer comprises a transparent polyolefin film and an embossed layer that has a first face that is embossed and that is coated with a protective material.

9. The multilayer film of claim 8, wherein the wear layer has only one face that is embossed.

10. The multilayer film of claim 8, wherein the wear layer has a second face opposed to the first face and which has a roughness below 20 μm.

11. The multilayer film of claim 8, wherein the base layer comprises a bi-axially oriented opaque polyolefin film selected from the group consisting of polypropylene, polyethylene, and a copolymer thereof.

12. The multilayer film of claim 11, wherein the transparent polyolefin film is bi-axially oriented.

13. The multilayer film of claim 8, further comprising an adhesive layer between the base layer and the wear layer.

14. (canceled)

15. The multilayer film of claim 8, wherein the base layer has a first face and a second face, opposed to the first face, that both have a roughness below 20 μm.

16. (canceled)

17. The multilayer film of claim 8, wherein the base layer and/or the wear layer comprise a UV-stabilizer.

18. The multilayer film of claim 8, wherein the protective material is a protective lacquer.

19-21. (canceled)

22. The multilayer film of claim 18, wherein the protective lacquer is matted.

23. The multilayer film of claim 18, wherein the protective lacquer comprises at least one of Quartz, Topaz, or Corundum particles.

24. A decorative article comprising:
a flooring article or a furniture article; and
the multilayer film of claim 8 applied on a face of the flooring article or the furniture article.

25. The decorative article of claim 24, further comprising an adhesive layer between the flooring article or the furniture article and the base layer of the multilayer film.
